(19) United States
(12) Patent Application Publication
(10) Pub. No.: US 2025/0054664 A1
(43) Pub. Date: Feb. 13, 2025

(54) HOT-DEFORMED R-Fe-B MAGNET FOR VARIABLE-MAGNETIC-FORCE MOTOR, VARIABLE-MAGNETIC-FORCE MOTOR, AND ELECTRONIC DEVICE FOR VEHICLE AND HOUSEHOLD

(71) Applicant: National Institute for Materials Science, Tsukuba-shi, Ibaraki (JP)

(72) Inventors: Xin TANG, Tsukuba-shi (JP); Hossein SEPEHRI AMIN, Tsukuba-shi (JP); Tadakatsu OHKUBO, Tsukuba-shi (JP); Kazuhiro HONO, Tsukuba-shi (JP)

(73) Assignee: National Institute for Materials Science, Tsukuba-shi, Ibaraki (JP)

(21) Appl. No.: 18/718,520

(22) PCT Filed: Dec. 12, 2022
(86) PCT No.: PCT/JP2022/045683

§ 371 Date: Jun. 11, 2024

(30) Foreign Application Priority Data
Dec. 13, 2021 (JP) 2021-201427

(51) Int. Cl. H01F 1/057; C22C 38/00; C22C 38/10; H02K 1/02

(52) U.S. Cl. CPC H01F 1/0577; C22C 38/002; C22C 38/005; C22C 38/10; C22C 2202/02; H02K 1/02

(57) ABSTRACT

This hot-deformed R—Fe—B magnet for a variable-magnetic-force motor is an R₂—Fe₁₄—B (R is at least one rare earth element selected from among Nd, La, Ce, and Y)-based hot-deformed magnet, including, in atom %, 12.2% or more and 14.5% or less of R₂(Nd_{1-x-y-z}LaₓCe_{y}Y_{z}), where (0.0≤x≤0.2, 0.0≤y+z≤0.3), 5% or more and 6.5% or less of B, 0.0% or more and 5.0 or less of Co, and 0.0% or more and 1.0 or less of Ga, with the balance being made up of Fe and inevitable impurities.

### TECHNICAL FIELD

The present invention relates to a hot-deformed R—Fe—B magnet for a variable-magnetic-force motor, a variable-magnetic-force motor, and an electronic device for vehicles and households.

Priority is claimed on Japanese Patent Application No. 2021-201427, filed Dec. 13, 2021, the content of which is incorporated herein by reference.

### BACKGROUND ART

In conventional permanent magnet motors, high-performance Nd—Fe—B-based permanent magnets with a large residual magnetization and a large coercive force are used. Regarding Nd—Fe—B-based permanent magnets, for example, Patent Document 1 discloses a composition thereof, and Patent Documents 2 and 3 propose improvements suitable for electric vehicle motors. Nd—Fe—B-based permanent magnets are permanently magnetized in permanent magnet motors that operate at various rotational speeds. A strong permanent magnet is required when an automobile accelerates, but a high torque is not required when the motor rotates at medium to high speeds, and thus a large magnetic flux of the permanent magnet is not required.

The problem is that, as the rotational speed of the motor increases, coils require a current to weaken the magnetic flux, for which an additional voltage is required. Since there is an upper limit to the supply voltage, conventional permanent magnet motors have a problem that there is a limit to the operation speed [Non-Patent Documents 1-2].

In order to solve this problem, a variable-magnetic-force (VMF) motor that can control the magnetization of a permanent magnet according to a rotational speed of the motor, and reduce a magnetic flux-weakening current during medium- to high-speed operation of the motor has been verified. Therefore, it is possible to efficiently operate a high-output motor in a wide range of rotational speeds. Since the magnetization of the permanent magnet used in VMF motors needs to be changed during operation depending on a desired magnetic flux, the permanent magnet needs to have an appropriate coercive force of about 0.2 to 0.65 T so that the magnetization of the permanent magnet can be changed in a limited magnetic field generated from coils [Non-Patent Documents 1-2].

In addition, the magnetization changes sharply near the coercive force, and a flat minor magnetization curve is essentially desired. In addition, a large residual magnetization is required for these magnets.

There are two reasons why conventional Nd—Fe—B-based sintered magnets cannot be used for VMF motor applications [Non-Patent Documents 1-2]. The first reason is that conventional Nd—Fe—B-based sintered magnets have a large coercive force that is not necessary for VMF motors. The second reason is that a small magnetization curve of conventional Nd—Fe—B-based sintered magnets cannot maintain magnetization, the magnetization of the magnet increases as the magnetic field increases, and thus the magnetic flux of the permanent magnet cannot be easily controlled, which is not beneficial for VMF motors.

In recent years, sintered magnets using (Nd,Sm)Fe—B powder treated using hydrogenation-disproportionation-desorption-recombination (HDDR) have had a coercive force as small as 0.2 T, and the shape of the minor loop can be partially changed. However, the residual magnetization of a sintered (Nd,Sm)—Fe—B magnet is only 1.06 T, which has limited the maximum magnetic flux of the magnet.

Another promising material for VFM motors is a hot-deformed Nd—Fe—B-based permanent magnet, and when a total Nd content is adjusted while maintaining a large residual magnetization of 1.4-1.5 T, a small coercive force of 1.2-1.4 T can be achieved.

It has been reported that the lower limit of the coercive force of an anisotropic hot-deformed neodymium magnet is about 0.9-1.0 T for an alloy having a slightly larger Nd content than that of a stoichiometric composition. When the Nd content in the alloy is further reduced, the Nd-rich grain boundary phase disappears, which is critically important in order to achieve a texture and large energy density of the hot-deformed magnet. Another method of reducing the coercive force while maintaining the neodymium-rich phase of the hot-deformed neodymium magnet is replacement of LRE with neodymium, which is known to reduce the crystal anisotropy of the 2-14-1 base phase.

### CITATION LIST

### Patent Document

### [Patent Document 1]

Japanese Unexamined Patent Application, First Publication No. 2002-190404

### [Patent Document 2]

WO 2019/230457

### [Patent Document 3]

Japanese Unexamined Patent Application, First Publication No. 2021-44361

### Non-Patent Document

### [Non-Patent Document 1]

K. Sakai, K. Yuki, Y. Hashiba, N. Takahashi, and K. Yasui, in Proc. 2009 Int. Conf. Elect. Mach. Syst., (2009) 1-6.

### [Non-Patent Document 2]

N. Limsuwan, et. al., “Design and evaluation of a variable-flux flux-intensifying interior permanent magnet machine,” IEEE Trans. Ind. Appl., 50 (2014) 1015-1024.

### [Non-Patent Document 3]

Keiko Hioki, et al. “Improving performance of hot-deformed neodymium magnets by grain boundary diffusion method,” Denkki Seiko, vol. 92, pp. 11 to 18 (2021)

### [Non-Patent Document 4]

Taisuke Sasaki, Tadakatsu Okubo, Kazuhiro Takarano “Microstructure of neodymium sintered magnets-grain boundary phase and interfacial structure,” Journal of the Japan Institute of Metals and Materials, vol. 81, pp. 2 to 10 (2017)

### [Non-Patent Document 5]

Kazuhiro Takarano, Tadakatsu Okubo, H. Sepehri-Amin, “Microstructure control for increasing the coercive force of Nd—Fe—B magnets,” Journal of the Japan Institute of Metals and Materials, vol. 76, pp. 2 to 11 (2012)

### SUMMARY OF INVENTION

### Technical Problem

As described above, the reason why conventional Nd—Fe—B-based sintered magnets cannot be used for application to VMF motors is that (i) a Nd—Fe—B-based sintered magnet with a conventional composition has a large coercive force that is not necessary for VMF motors, and (ii) the slanted minor loop is not beneficial for VMF motors because it is difficult to control the magnetic flux. Here, the minor loop is a loop curve in which the magnetism is not saturated, unlike a magnetic saturation curve.

In order to solve the above problems, an object of the present invention is to provide a hot-deformed R—Fe—B magnet for a variable-magnetic-force motor which has a small coercive force required for VMF motors and in which a magnetic flux of a permanent magnet can be easily controlled, a variable-magnetic-force motor, and an electronic device for vehicles and households.

### Solution to Problem

In order to explore the possibility of VMF application of hot-deformed (Nd,LRE)-Fe—B(LRE=Y,La,Ce) magnets, the inventors evaluated the magnetic characteristics and minor loops of hot-deformed (Nd_{0.8}LRE_{0.2})₂Fe₁₄B magnets, and completed the present invention.

In addition, in order to explore the possibility of VMF application of hot-deformed (Nd,Sm,LRE)-Fe—B(LRE=La,Ce) magnets, the inventors evaluated the magnetic characteristics and minor loops of hot-deformed (Nd_{0.8}Sm_{0.1}LRE_{0.1})₂Fe₁₄B magnets, and completed the present invention.

[1] For example, as shown in Table 3, a hot-deformed R—Fe—B magnet for a variable-magnetic-force motor of the present invention, which is an R₂—Fe₁₄—B (R is at least one rare earth element selected from among Nd, La, Ce, and Y)-based hot-deformed magnet, includes, in atom %,
12.2% or more and 14.5% or less of R₂(Nd_{1-x-y-z}LaₓCe_{y}Y_{z}), where (0.0≤x≤0.2, 0.0≤y+z≤0.3),
5% or more and 6.5% or less of B,
0.0% or more and 5.0 or less of Co, and
0.0% or more and 1.0 or less of Ga,
with the balance being made up of Fe and inevitable impurities.
   [2] In the hot-deformed R—Fe—B magnet for a variable-magnetic-force motor of [1] of the present invention, preferably, the residual magnetic flux density μ₀Mr is 1.3 T or more, and the coercive force μ₀Hc is in a range of 0.1 T or more and 1.6 T or less.
   [3] For example, as shown in Table 3, a hot-deformed R—Fe—B magnet for a variable-magnetic-force motor of the present invention, which is an R₂-Feta-B (R includes Nd and La, and additionally optionally includes at least one rare earth element such as Ce and Y)-based hot-deformed magnet, includes, in atom %,
12.2% or more and 14.5% or less of R₂(Nd_{1-x-y-z}LaₓCe_{y}Y_{z}), where (0.05≤x≤0.4, 0.0≤y+z≤0.3),
5% or more and 6.5% or less of B,
0.0% or more and 5.0 or less of Co, and
0.0% or more and 1.0 or less of Ga,
with the balance being made up of Fe and inevitable impurities.
   [4] In the hot-deformed R—Fe—B magnet for a variable-magnetic-force motor of [3] of the present invention, preferably, the residual magnetic flux density μ₀Mr is 1.0 T or more and 1.30 T or less, and the coercive force μ₀Hc is in a range of 0.15 T or more and 1.2 T or less.
   [5] For example, as shown in Table 3, a hot-deformed R—Fe—B magnet for a variable-magnetic-force motor of the present invention, which is an R₂—Fe₁₄—B (R includes Nd and La, and additionally includes at least one rare earth element such as Ce and Y)-based hot-deformed magnet, includes, in atom %,
12.2% or more and 14.5% or less of R₂(Nd_{1-x-y-z}LaₓCe_{y}Y_{z}), where (0.2≤x≤0.35, 0.1≤y+z≤0.4),
5% or more and 6.5% or less of B,
0.0% or more and 5.0 or less of Co, and
0.0% or more and 1.0 or less of Ga,
with the balance being made up of Fe and inevitable impurities.
   [6] In the hot-deformed R—Fe—B magnet for a variable-magnetic-force motor of [5] of the present invention, preferably, additionally, the residual magnetic flux density μ₀Mr is 1.0 T or more and 1.25 T or less, and the coercive force μ₀Hc is in a range of 0.15 T or more and 1.1 T or less.
   [7] For example, as shown in Table 5, a hot-deformed R—Fe—B magnet for a variable-magnetic-force motor of the present invention, which is an R₂—Fe₁₄—B (R includes Nd and Sm, and additionally includes at least one rare earth element such as Ce and La)-based hot-deformed magnet, includes, in atom %, 12.2% or more and 14.5% or less of R₂(Nd_{1-s-x-y}SmₛLaₓCe_{y}), where (0.0<s≤0.2, 0.0≤x+y≤0.2),
5% or more and 6.5% or less of B,
0.0% or more and 5.0 or less of Co, and
0.0% or more and 1.0 or less of Ga,
with the balance being made up of Fe and inevitable impurities.
   [8] In the hot-deformed R—Fe—B magnet for a variable-magnetic-force motor of [7] of the present invention, preferably, additionally, the residual magnetic flux density μ₀Mr is 1.0 T or more and 1.4 T or less, and the coercive force μ₀Hc is in a range of 0.1 T or more and 0.7 T or less.
   [9] A variable-magnetic-force motor using any one of the hot-deformed R—Fe—B magnets for a variable-magnetic-force motor [1] to [8].
   [10] A vehicle using any one of the hot-deformed R—Fe—B magnets for a variable-magnetic-force motor [1] to [6]. The vehicle can be, for example, an automobile or a motorcycle. The vehicle uses the variable-magnetic-force motor.
   [11] A household electronic device using any one of the hot-deformed R—Fe—B magnets for a variable-magnetic-force motor [1] to [6].

The household electronic device may be, for example, any of a washing machine, a refrigerator, a freezer, and a vacuum cleaner. The household electronic device uses the variable-magnetic-force motor.

### Advantageous Effects of Invention

According to the hot-deformed R—Fe—B magnet for a variable-magnetic-force motor of the present invention, a hot-deformed R—Fe—B magnet for a variable-magnetic-force motor which has a small coercive force required for VMF motors and in which a magnetic flux of a permanent magnet can be easily controlled is obtained.

### BRIEF DESCRIPTION OF DRAWINGS

FIG. 1 is a diagram illustrating a flat minor magnetization curve and a flatness factor of a hot-deformed magnet of the present invention.

FIG. 2(a) shows a demagnetization curve of a hot-deformed Nd_{0.8}LRE_{0.2} magnet, which is an example of the present invention, and FIG. 2(b) shows the dependence of a coercive force of the hot-deformed Nd_{0.8}LRE_{0.2} magnet, which is an example of the present invention, on the temperature.

FIG. 3 shows captured high-magnification cross-sectional BSE-SEM images of various hot-deformed magnets, FIG. 3(a) shows an image of LRE-free, FIG. 3(b) shows an image of Nd_{0.8}Ce_{0.2}, FIG. 3(c) shows an image of Nd_{0.8}Y_{0.2}, and FIG. 3(d) shows an image of Nd_{0.8}La_{0.2}, which is an example of the present invention.

FIG. 4(a) shows minor loops of a sintered Nd—Fe—B magnet. FIG. 4(b) shows minor loops of Nd—Fe—B, FIG. 4(c) shows minor loops of Nd_{0.8}Ce_{0.2}—Fe—B, and FIG. 4(d) shows minor loops of a Nd_{0.8}La_{0.2} hot-deformed R—Fe—B magnet.

FIG. 4(e) shows minor loops of the sintered Nd—Fe—B magnet, and FIG. 4(f) shows selected minor loops measured based on SQUID-VSM and Kerr data of a hot-deformed Nd_{0.8}La_{0.2}—Fe—B magnet.

FIG. 5(a) shows a sintered Nd—Fe—B magnet and FIG. 5(b) shows a change in the magnetic domain of a hot-deformed Nd_{0.8}La_{0.2}—Fe—B magnet under a magnetic field.

FIG. 6 is a diagram illustrating magnetic characteristics of various anisotropic hot-deformed magnets of the present invention, and the horizontal axis represents the coercive force μ₀Hc(T), and the vertical axis represents the residual magnetic flux density μ₀Mr(T).

FIG. 7(a) shows a first order reversal curve (FORC) of a hot-deformed (Nd_{0.8}Sm_{0.1}Ce_{0.1})—Fe—B magnet, and FIG. 7(b) shows an FORC of a hot-deformed (Nd_{0.8}Sm_{0.1}La_{0.1})—Fe—B magnet.

FIG. 8(a) shows BSE-SEM images of a hot-deformed (Nd_{0.8}Sm_{0.1}Ce_{0.1})—Fe—B magnet, FIG. 8(b) shows BSE-SEM images of a hot-deformed (Nd_{0.8}Sm_{0.1}La_{0.1})—Fe—B magnet, and each left side image is a low-magnification image, and each right side image is a high-magnification image.

FIG. 9(a) shows hysteresis curves of a hot-deformed (Nd_{0.8}Sm_{0.1}La_{0.1})—Fe—B magnet subjected to a grain boundary diffusion process and a hot-deformed (Nd_{0.8}Sm_{0.1}La_{0.1})—Fe—B magnet not subjected to a grain boundary diffusion process, and FIG. 9(b) is a graph showing the dependence of respective coercive forces on the temperature.

FIGS. 10(a) and 10(b) show BSE-SEM images of a hot-deformed (Nd_{0.8}Sm_{0.1}La_{0.1})—Fe—B magnet itself, FIGS. 10(c) and 10(d) show BSE-SEM images of a hot-deformed (Nd_{0.8}Sm_{0.1}La_{0.1})—Fe—B magnet subjected to a Nd—Cu diffusion treatment, FIGS. 10(a) and 10(c) show low-magnification images, and FIGS. 10(b) and 10(d) show high magnification.

FIG. 11 shows FORCs of a hot-deformed (Nd_{0.8}Sm_{0.1}La_{0.1})—Fe—B magnet subjected to a Nd—Cu diffusion treatment, FIG. 11(a) shows FORCs at room temperature, and FIG. 11(b) shows FORCs at 460 K.

FIG. 12 is a main-part configuration diagram, which shows an example of a variable-magnetic-force motor used in the hot-deformed magnet of the present invention.

### DESCRIPTION OF EMBODIMENTS

In this specification, as a general rule, if upper limit and lower limit boundary values are included, “to” indicating a numerical range means “or more” and “or less,” but “less than” or “more than” is meant if upper limit and lower limit boundary values are not included.

### <Process of Producing Hot-Deformed Magnet>

An alloy ingot (hereinafter referred to as Nd_{0.8}LRE_{0.2}) having a composition of (Nd_{0.8}LRE_{0.2})_{14.0}Fe_{75.7}Co_{4.52}Ga_{0.54}B_{5.24}at % (LRE=Y,La,Ce) was produced by induction melting of high-purity elements and cast into a low-carbon-steel mold. This ingot was subjected to liquid quenching with a Cu wheel at 30 m/s to obtain an isotropic nanocrystalline ribbon. The quenched ribbon was hot-pressed and molded at 650° C. in a vacuum of 380 MPa, and additionally thermally pressed to a height of 75% at 780° C. in an argon atmosphere.

### <Process of Producing Sintered Nd—Fe—B Magnet>

A Nd_{14.0}Fe_{75.7}Co_{4.52}Ga_{0.54}B_{5.24}at % alloy ingot was produced by induction melting. Strip cast flakes were produced from the ingot by a strip casting method. The strip casting method was a casting method in which a metal material was melted, and the molten metal was poured onto a copper roll and quenched and solidified. The strip cast flakes were quenched and solidified flakes of RE-Fe—B-based alloys for sintered magnets. The wheel speed was 1 to 5 m/s. The strip cast flakes were subjected to hydrogen reduction at a temperature of 150 to 220° C. for 1 to 5 hours. Then, jet mill powder with an average grain size of 1 to 5 μm was prepared from the hydrogen-decrepitated powder. This jet mill powder was aligned in a magnetic field to produce a green compact. Sintering was performed under a vacuum at a temperature of 900 to 1,150° C. for 2 to 9 hours. Annealing after sintering was performed at 500 to 680° C. for 1 to 5 hours.

### <Measurement of Magnetic Characteristics>

The magnetic characteristics at room temperature were measured using a BH tracer, and the temperature-dependent coercive force and the minor loop were obtained using a superconducting quantum interference device-vibrating sample magnetometer (SQUID-VSM) under a maximum applied magnetic field of 7 T. In addition, the microstructure was examined under an SEM using CrossBeam 1540 EsB (commercially available from Carl Zeiss AG).

The anisotropic magnetic field of the anisotropic magnet was measured using a DynaCool physical property measurement system (PPMS) under a maximum applied magnetic field of 14 T. In addition, in order to examine propagation of magnetic domains, a magneto-optic Kerr effect (MOKE) microscope was used. The sample was cut into a size of 2.5 mm×0.6 mm×3 mm (c-axis), and pre-magnetized using a pulse magnetization device under a maximum magnetic field of 5 T. Pure magnetic domain contrast was obtained by subtracting background information after the magnet was saturated again under a maximum magnetic field of 1.3 T using an MOKE microscope.

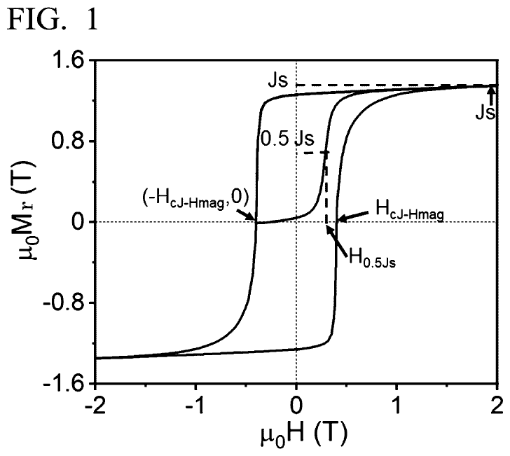

FIG. 1 is a diagram illustrating a flat minor magnetization curve and a flatness factor of a hot-deformed magnet of the present invention, the horizontal axis represents the coercive force μ₀He, and the vertical axis represents the residual magnetic flux density μ₀Mr. The following flatness factor is defined using the saturation magnetic flux density Js and the coercive force μ₀He in the J-H demagnetization curve. The J-H demagnetization curve shows how much the magnetization of the magnet changes due to an external magnetic field.

Here, F_{f} is the flatness factor, 0.5Js is the half value of the saturation magnetic flux density Js, H_{0.5Js} is the value of the magnetic field corresponding to 50% of the saturation magnetic flux density Js and is the value of the coercive force μ₀He when the residual magnetic flux density μ₀Mr is zero, and H_{c}J-H_{mag} is the coercive force of the saturated J-H curve when the residual magnetic flux density μ₀Mr is zero or the coercive force value He.

$$Flatness factor ( {F}_{f} ) = {H}_{0.5 Js} / {H}_{cJ - Hmag} \qquad [ Math . 1 ]$$

<Measurement of Magnetic Characteristics of Hot-Deformed Nd_{0.8}LRE_{0.2} Magnet (LRE=Ce,La,Y)>

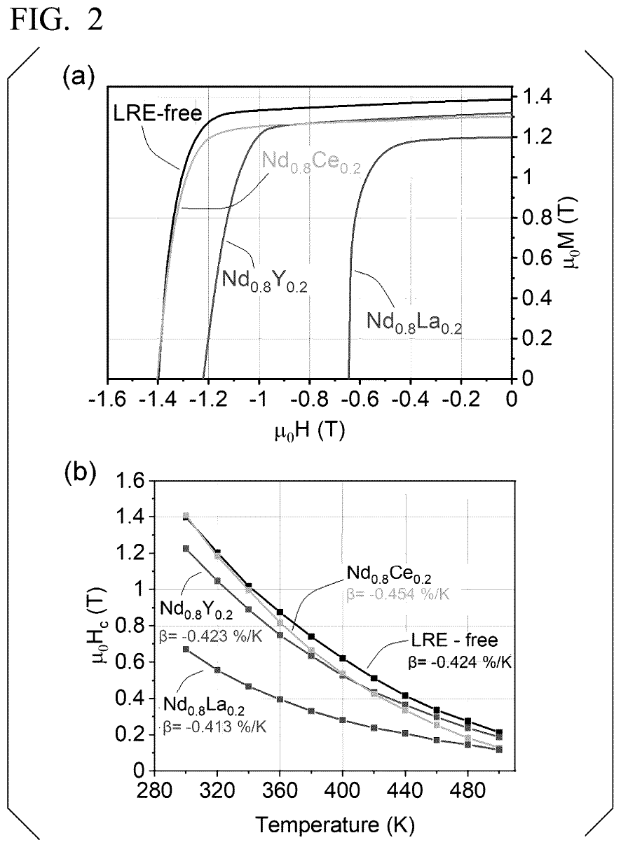

FIG. 2(a) shows the demagnetization curve of the hot-deformed Nd_{0.8}LRE_{0.2} magnet (LRE=Ce,La,Y) at room temperature. In the LRE-free magnet, a coercive force of 1.40 T and a residual magnetization (0Mr) of 1.38 T were obtained. On the other hand, for Nd_{0.8}Y_{0.2}—Fe—B, the coercive force was 1.22 T, and the residual magnetization was 1.32 T, which were lower values than those of the LRE-free magnet. FIG. 2(b) shows the dependence of the coercive force and the coercive force coefficient ((3) of the hot-deformed Nd_{0.8}LRE_{0.2} magnet from 300 K to 500 K on the temperature. In the LRE-free sample, the β value was measured as −0.424%/K.

In the Nd_{0.8}Ce_{0.2} sample, the R value decreased to −0.454%/K. However, in the Nd_{0.8}Y_{0.2} sample, β=−0.423%/K, and the thermal stability of the coercive force did not decrease compared to the LRE-free sample. In the Nd_{0.8}LRE_{0.2}—Fe—B sample, the magnet with Ce replaced showed the largest coercive force at room temperature, but the sample with Y added had high thermal stability of the coercive force, the coercive force at room temperature was moderate, and at high temperatures (>420 K), the Nd_{0.8}Y_{0.2} sample could obtain a larger coercive force than the Nd_{0.8}Ce_{0.2} sample.

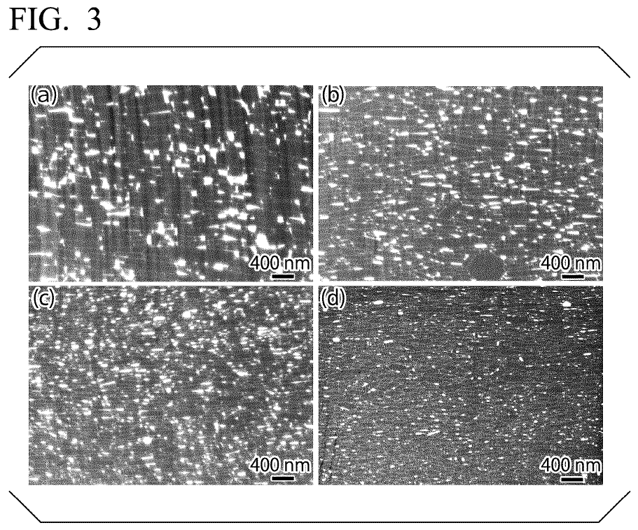

FIG. 3 shows backscattered electron (BSE) SEM images obtained from the magnet without LRE and the high-temperature processed magnet with LRE added. In all samples, the 2:14:1 crystal grains exhibiting gray contrast were surrounded by a thin RE-rich intergranular phase (looked brightly). The platelet-like 2-14-1 grains were oriented so that the c-axis was parallel to the loading direction after hot-deforming. The average crystal grain sizes of the samples were calculated based on the BSE-SEM image and summarized in Table 1. Table 1 shows the average crystal grain sizes Dc and Dab, the anisotropic magnetic field Ha and the saturation magnetization μ₀Ms of the hot-deformed Nd_{0.8}LRE_{0.2} samples.

TABLE 1
Average grain sizes, anisotropy field
μ₀Hₐ of Nd_{0.8}LRE_{0.2} hot-deformed magnets

| Sample | LRE-free | Nd_{0.8}Y_{0.2} | Nd_{0.8}Ce_{0.2} | Nd_{0.8}La_{0.2} |
|---|---|---|---|---|
| D_{c} (nm) | 490 | 280 | 400 | 190 |
| D_{ab} (nm) | 110 | 61 | 90 | 53 |
| μ₀Hₐ (T) | 6.7 | 6.0 | 6.4 | 5.1 |

The grain size varied depending on the type of LRE used in the alloy composition. The largest average crystal grain size was obtained in the sample without LRE (about 421 nm (Dc) along the c-plane and about 110 nm (Dab) in a direction perpendicular to the c-plane). The Nd_{0.8}La_{0.2} sample had the smallest average grain size, with a width (Dc) of about 186 nm, a height (Dab) of about 59 nm, and an increased volume fraction of grain boundaries. In addition, the area percentage of RE-rich triple junctions with bright contrast decreased significantly from 10.3% in the LRE-free sample to 4.6% in the Nd_{0.8}La_{0.2} sample. As a result, in FIG. 3(d), the grain boundaries appeared dark.

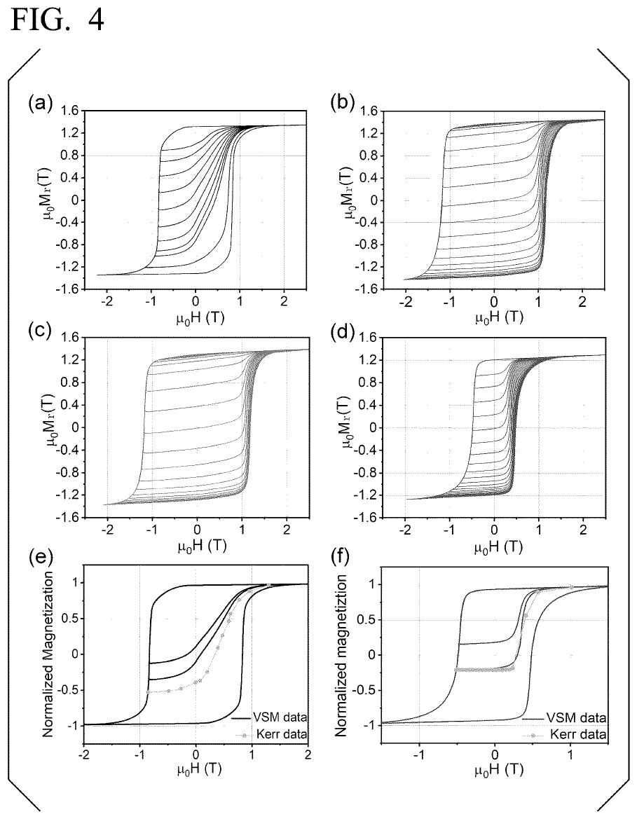

FIG. 4(a) shows FORCs of a commercially available N50 type sintered Nd—Fe—B magnet having a composition of Nd_{11.73}Pr_{2.87}Fe_{77.69}Co_{1.04}Cu0.09Al0.49B6.09 (at. %) measured using the SQUID-VSM.

The external magnetic field was reduced from 7.0 T to a different value in the second quadrant, and saturation was then performed again to 7 T. Accordingly, the FORC of the magnet could be evaluated. As shown in FIG. 4(a), the magnetization value of the sintered magnet easily changed as the magnetic field in the second quadrant increased. This means that the magnetic flux of the sintered Nd—Fe—B magnet could not be easily controlled and this was not suitable for application to VMF motors. In contrast, as shown in FIG. 4(b-d), the FORCs of the hot-deformed Nd—Fe—B and (Nd_{0.8}LRE_{0.2})—Fe—B magnets were much flatter than those of the sintered magnet. This seems to be due to ultrafine crystal grains of the hot-deformed Nd—Fe—B magnet, regardless of the dopant (Ce,Y,La), and the magnetization value of the minor loop was more robust to change in the external magnetic field. In the case of the hot-deformed (Nd_{0.8}La_{0.2})—Fe—B magnet, it should be noted that, not only was a flat FORC observed, but a moderate coercive force of 0.5 T and a sharp magnetization transition around the coercive force value were also observed. The coercive force value measured using the SQUID-VSM was slightly smaller than the coercive force value measured using the B—H tracer. The reason is that, unlike the B—H tracer sample, a small amount of the sample was required for SQUID-VSM measurement, and the coercive force slightly decreased when the surface of the magnet was polished.

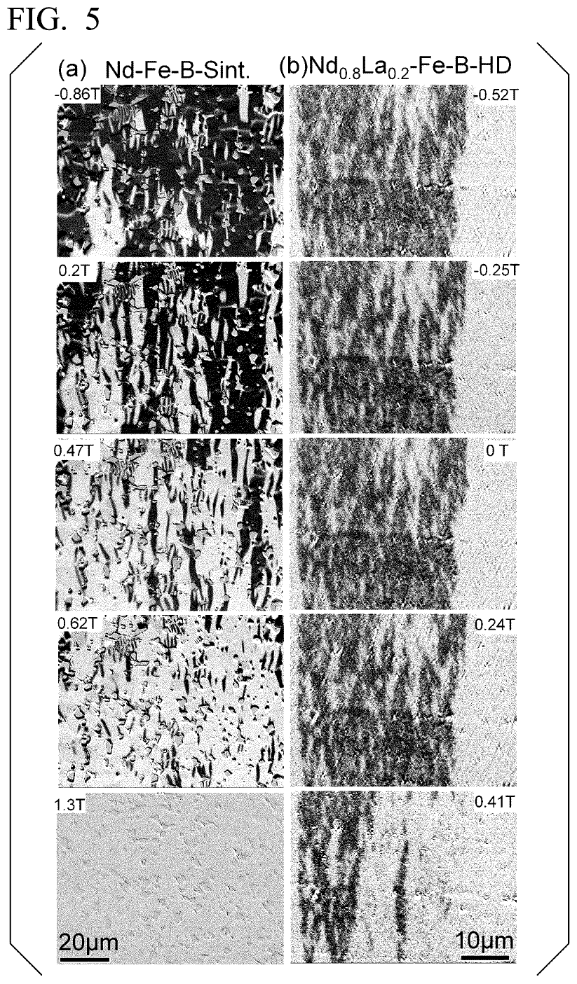

Here, a method of controlling the shape of the FORC based on propagation of magnetic domains using an MOKE microscope will be described. As shown in FIG. 5, after the magnetization of the sample was saturated, the magnetic field decreased and the reverse magnetic domain was observed. The magnetic field was then increased again toward saturation magnetization in order to understand how propagation of domain walls occurs. The experimental design of the applied magnetic field imitated the FORC shown in FIG. 4. In the MOKE image shown in FIG. 5(a), the area percentage of the reverse magnetic domain with black contrast was determined to be 73% at −0.86 T. A clear multi-magnetic domain structure appeared, and the area percentage of reversed magnetic domains decreased to 59% at 0.2 T. When the magnetic field was further increased to 0.47 T, the domain walls of the multi-magnetic domain structure were easily displaced, and thus the area percentage of the reverse magnetic domain significantly decreased to 33%. This matches the observations by X-ray magnetic circular dichroism (XMCD).

The magnetization values normalized in the magnetic fields were plotted based on the magnetic domain contrast of the MOKE data. The FORCs constructed from the MOKE data were plotted in FIG. 4(e) and compared with the FORCs measured using the SQUID-VSM. The FORCs obtained from the MOKE data showed the same trend as the FORCs obtained from the SQUID-VSM data. That is, the magnetization gradually increased as the external magnetic field of the sintered magnet increased. On the other hand, based on the MOKE results shown in FIG. 5(b), it can be understood that, in the hot-deformed (Nd_{0.8}La_{0.2})—Fe—B magnet, even if the magnetic field increased from −0.52 T to 0.24 T in the second quadrant of the magnetization curve, the magnetic domain did not propagate easily. FIG. 4(f) shows the normalized magnetization curve obtained from the MOKE image of the hot-deformed (Nd_{0.8}La_{0.2})—Fe—B magnet. The MOKE image clearly explains that the reason for controlling the magnetization value of the FORC is a pinning effect at the grain boundary phase of a hot-deformed (Nd_{0.8}La_{0.2})—Fe—B magnet with an ultrafine grain size.

Table 2 shows the magnetic characteristics of the sintered Nd—Fe—B magnet and the hot-deformed Nd—Fe—B magnet as comparative examples, and the hot-deformed (Nd_{0.6}La_{0.3}Ce_{0.1})—Fe—B magnet, which is an example of the present invention. As the magnetic characteristics, the coercive force μ₀H_{c}, the residual magnetic flux density μ₀Mᵣ and the flatness factor F_{f} are shown.

TABLE 2

| Sample | μ₀H_{c} (T) | μ₀Mᵣ (T) | F_{f} |
|---|---|---|---|
| Nd—Fe—B sint. | 0.845 | 1.42 | 0.385 |
| Nd—Fe—B-HD | 1.53 | 1.405 | 0.925 |
| (Nd_{0.6}La_{0.3}Ce_{0.1})—Fe—B | 0.435 | 1.26 | 0.75 |

<Summary: Magnetic Characteristics of Hot-Deformed Nd_{0.8}LRE_{0.2} Magnet (LRE=Ce,La,Y)>

Based on the above results, it can be understood that Ce could replace Nd in order to obtain a high coercive force at room temperature, Y improved the thermal stability of the coercive force, and La more negatively influenced the external characteristics than Ce and Y. The dependence of coercive force on temperature reported in the present invention indicates that a coercive force of 0.8 T or more could be maintained at a temperature of 360 K or less in the hot-deformed Nd_{0.8}LRE_{0.2}—Fe—B(LRE=Ce,Y) magnet and indicates a possibility of applications such as a wind turbine at a medium temperature (90° C.). In addition, in order to expand applications of LRE-replaced magnets, a possibility of applying the hot-deformed Nd_{0.8}LRE_{0.2}—Fe—B magnet to variable magnetic force (VMF) motors to improve motor efficiency in a wide range of rotational speeds was considered. In order to satisfy requirements of permanent magnets for VMF application, an appropriate coercive force of 0.2 to 0.65 T, a high residual magnetization, and a flat FORC were desirable.

The sintered Nd—Fe—B magnet could not be selected for this application because it had a relatively large coercive force. In addition, in the VMF motor, since there was a large variation in the shape of the FORC of magnetization, the magnetization value could not be accurately adjusted.

In the present invention, as shown in FIG. 4 and FIG. 5, in order to control the shape of the FORC of magnetization, it was necessary to better control propagation of domain walls. When the grain size was reduced, the multi-magnetic domain structure often observed in conventional sintered Nd—Fe—B magnets changed to a single magnetic domain structure in hot-deformed magnets. In addition, in ultrafine crystal grain magnets, the volume fraction of grain boundaries became large, which acted as pinning sites for domain wall propagation during the re-magnetization procedure. As a result, a flat FORC required for VFM applications was obtained. Therefore, the ultrafine-grained hot-deformed magnet was an attractive option for use in VMF applications. The inventors verified that, when 20% of La was replaced with Nd, it was possible to not only reduce the magnet cost, but also reduce the coercive force of the magnet to μ₀Hc=0.48 T, which is a range suitable for application to VMF motors.

As shown in Table 2 above, this appropriate coercive force was achieved by controlling specific magnetic characteristics of the matrix (Nd, La)₂Fe₁₄B phase. In addition, the large residual magnetization of 1.2 T of the hot-deformed (Nd_{0.8}La_{0.2})Fe—B magnet was also an advantage leading to an increase in output of the VFM motor.

In conclusion, the possibility of applying (Nd_{0.8}LRE_{0.2})₂Fe₁₄B high-temperature processed magnets to variable magnetic force (VMF) motors was examined. The (Nd_{0.8}Ce_{0.2})₂Fe₁₄B magnet exhibited a higher coercive force of 1.41 T and a lower residual magnetization of 1.30 T than the LRE-free magnet, and the (Nd_{0.8}Y_{0.2})₂Fe₁₄B magnet exhibited an appropriate coercive force of 1.22 T and residual magnetization of 1.32 T without any decrease in thermal stability (β=−0.423%/K) of the coercive force.

When 20% of Nd was replaced with La, the coercive force was 0.48 T, and the residual magnetization was 1.2 T, which were adjusted to values suitable for application to VMF motors. A notable result of the present invention is that the shape of the FORC of the (Nd_{0.8}La_{0.2})₂Fe₁₄ magnet is flat, which is due to a large volume fraction of the crystal grain boundaries of the ultrafine hot-deformed magnet observed under an MOKE microscope. In addition, the FORC is flat due to the pinning effect.

The present invention indicates that the low-cost hot-deformed (Nd_{0.8}La_{0.2})₂Fe₁₄B magnet can be excellent candidates for application to VMF motors.

<Measurement of Magnetic Characteristics of Hot-Deformed Nd_{0.8}LRE_{0.2} Magnet (LRE=Ce,La,Y)>

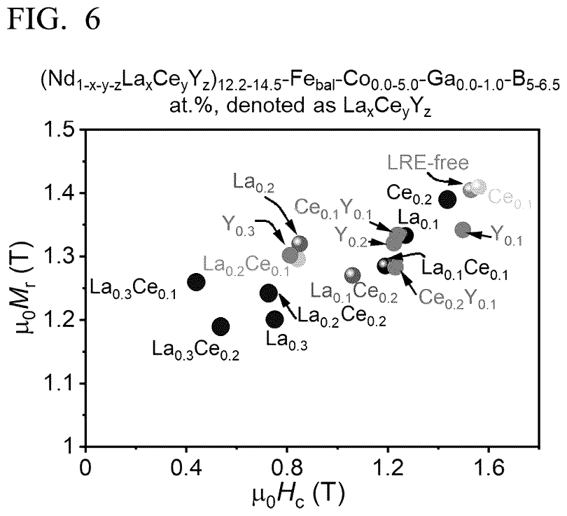

FIG. 6 is a diagram illustrating magnetic characteristics of various anisotropic hot-deformed magnets of the present invention, and the horizontal axis represents the coercive force μ₀Hc(T), and the vertical axis represents the residual magnetic flux density μ₀Mr(T).

Table 3 is a table showing element compositions of various anisotropic hot-deformed magnets shown in FIG. 6 at plotted measurement points of magnetic characteristics.

TABLE 3

| | Sample | μ₀H_{c} (T) | μ₀Mᵣ (T) |
|---|---|---|---|
| 1 | Nd—Fe—B | 1.53 | 1.405 |
| 2 | (Nd_{0.9}Ce_{0.1})—Fe—B | 1.56 | 1.41 |
| 3 | (Nd_{0.8}Ce_{0.2})—Fe—B | 1.44 | 1.39 |
| 4 | (Nd_{0.9}La_{0.1})—Fe—B | 1.27 | 1.333 |
| 5 | (Nd_{0.8}La_{0.2})—Fe—B | 0.85 | 1.32 |
| 6 | (Nd_{0.7}La_{0.3})—Fe—B | 0.75 | 1.2 |
| 7 | (Nd_{0.8}La_{0.1}Ce_{0.1})—Fe—B | 1.19 | 1.285 |
| 8 | (Nd_{0.7}La_{0.1}Ce_{0.2})—Fe—B | 1.06 | 1.27 |
| 9 | (Nd_{0.7}La_{0.2}Ce_{0.1})—Fe—B | 0.842 | 1.296 |
| 10 | (Nd_{0.6}La_{0.2}Ce_{0.2})—Fe—B | 0.727 | 1.24 |
| 11 | (Nd_{0.6}La_{0.3}Ce_{0.1})—Fe—B | 0.435 | 1.26 |
| 12 | (Nd_{0.5}La_{0.3}Ce_{0.2})—Fe—B | 0.534 | 1.19 |
| 13 | (Nd_{0.9}Y_{0.1})—Fe—B | 1.498 | 1.342 |
| 14 | (Nd_{0.8}Y_{0.2})—Fe—B | 1.224 | 1.321 |
| 15 | (Nd_{0.7}Y_{0.3})—Fe—B | 0.812 | 1.302 |
| 16 | (Nd_{0.8}Y_{0.1}Ce_{0.1})—Fe—B | 1.238 | 1.334 |
| 17 | (Nd_{0.7}Y_{0.1}Ce_{0.2})—Fe—B | 1.23 | 1.283 |

Table 4 shows composition ranges with desirable magnetic characteristics for the anisotropic hot-deformed R—Fe—B magnet for a variable-magnetic-force motor of the present invention. LaₓCe_{y}Y_{z} in (Nd_{1-x-y-z}LaₓCe_{y}Y_{z})_{12.2-14.5}—Fe_{bal}—Co_{0.0-5.0}—Ga_{0.0-1.0}—B_{5-6.5} (at. %) is used as a composition range parameter.

First preferable ranges of magnetic characteristics include a residual magnetic flux density μ₀Mr of 1.3 T or more and a coercive force μ₀Hc in a range of 0.1 T or more and 1.6 T or less, and such a composition range is LaₓCe_{y}Y_{z} (0.0≤x≤0.2, 0.0≤y+z≤0.3).

Second preferable ranges of magnetic characteristics include a residual magnetic flux density μ₀Mr of 1.1 T or more and 1.3 T or less and a coercive force μ₀Hc in a range of 0.15 T or more and 1.1 T or less, and such a composition range is LaₓCe_{y}˜Y_{z} (0.05≤x≤0.4, 0.0≤y+z≤0.3).

Optimal ranges of magnetic characteristics include a residual magnetic flux density μ₀Mr of 1.0 T or more and 1.25 T or less and a coercive force μ₀He in a range of 0.15 T or more and 0.7 T or less, and such a composition range is LaₓCe_{y}Y_{z} (0.2≤x≤0.35, 0.1≤y+z≤0.4).

TABLE 4
(Nd_{1-x-y-z}LaₓCe_{y}Y_{z})_{12.2-14.5}—Fe_{bal}—Co_{0.0-5.0}—Ga_{0.0-1.0}—B_{5-6.5}
at. % denoted as LaₓCe_{y}Y_{z}

| Range | | x | y + z |
|---|---|---|---|
| μ₀Mᵣ ≥ 1.3 T | 0.1 T ≤ μ₀H_{c} ≤ 1.6 T | 0.0-0.2 | 0.0-0.3 |
| 1.1 T ≤ μ₀Mᵣ ≤ 1.3 T | 0.15 T ≤ μ₀H_{c} ≤ 1.1 T | 0.05-0.4 | 0.0-0.3 |
| 1.0 T ≤ μ₀Mᵣ ≤ 1.25 T | 0.15 T ≤ μ₀H_{c} ≤ 0.7 T | 0.2-0.35 | 0.1-0.4 |

<Process of Producing Hot-Deformed Nd_{0.8}Sm_{0.1}LRE_{0.1} Magnet (LRE=Ce,La)>

An alloy ingot (hereinafter referred to as Nd_{0.8}Sm_{0.1}LRE_{0.1}) having a composition of (Nd_{0.8}Sm_{0.1}LRE_{0.1})_{12.9}Fe_{76.3}Co_{4.47}Ga_{0.50}B_{5.82}(at %) (LRE=La,Ce) was produced by induction melting of high-purity elements and cast into a low-carbon-steel mold. This ingot was subjected to liquid quenching with a Cu wheel speed at 30 m/s to obtain an isotropic nanocrystalline ribbon. The quenched ribbon was hot-pressed and molded at 630° C. in a vacuum of 380 MPa, and additionally thermally pressed to a height of 75% at 750° C. in an argon atmosphere.

In an example in which the hot-deformed Nd_{0.8}Sm_{0.1}LRE_{0.1} magnet (LRE=Ce,La) obtained in this manner was additionally subjected to a grain boundary diffusion method, this hot-deformed Nd_{0.8}Sm_{0.1}LRE_{0.1} magnet (LRE=Ce,La) was covered with a 4 wt % (relative to the weight of the hot-deformed magnet) Nd₈₀Cu₂₀ alloy, and then heated at 650° C. for 3 hours. In the hot-deformed Nd_{0.8}Sm_{0.1}LRE_{0.1} magnet (LRE=Ce,La), which was subjected to a grain boundary diffusion method using the Nd₈₀Cu₂₀ alloy as a diffusion material, Cu can be detected at the grain boundaries. Detection of Cu at the grain boundaries can be performed by EDS analysis under a scanning transmission electron microscope.

Examples of diffusion materials used in the grain boundary diffusion method include RE-M (RE: Pr, Nd, Th, Dy, M: Ga, Cu, Al).

Whether the hot-deformed magnet has been subjected to the grain boundary diffusion method can be determined by examining whether the elements constituting the diffusion material are contained in the grain boundaries.

<Measurement of Magnetic Characteristics of Hot-Deformed Nd_{0.8}Sm_{0.1}LRE_{0.1} Magnet (LRE=Ce,La)>

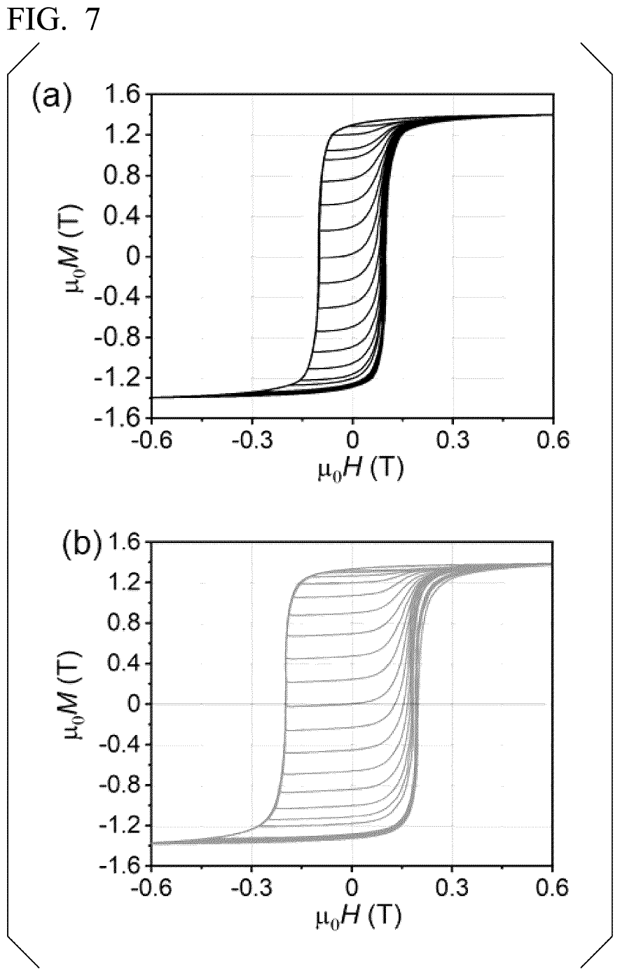

FIG. 7 shows FORCs of the hot-deformed Nd_{0.8}Sm_{0.1}LRE_{0.1} magnet (LRE=Ce,La), FIG. 7(a) shows an FORC with LRE=Ce, that is, an FORC of the hot-deformed (Nd_{0.8}Sm_{0.1}Ce_{0.1})—Fe—B magnet, and FIG. 7(b) shows an FORC with LRE=La, that is, an FORC of the hot-deformed (Nd_{0.8}Sm_{0.1}La_{0.1})—Fe—B magnet.

The flatness factors Fr of the hot-deformed (Nd_{0.8}Sm_{0.1}Ce_{0.1})—Fe—B magnet and the hot-deformed (Nd_{0.8}Sm_{0.1}La_{0.1})—Fe—B magnet were 0.83 and 0.87, respectively. These flatness factors F_{f} were superior to the flatness factor F_{f}(=0.75) of the hot-deformed (Nd_{0.6}La_{0.3}Ce_{0.1})—Fe—B magnet shown in Table 1.

In addition, the coercive force μ₀Hc and the residual magnetic flux density μ₀Mᵣ of the hot-deformed (Nd_{0.8}Sm_{0.1}Ce_{0.1})—Fe—B magnet were 0.16 T and 1.29 T, respectively, and the coercive force μ₀Hₑ and the residual magnetic flux density μ₀Mᵣ of the hot-deformed (Nd_{0.8}Sm_{0.1}La_{0.1})—Fe—B magnet were 0.26 T and 1.35 T, respectively.

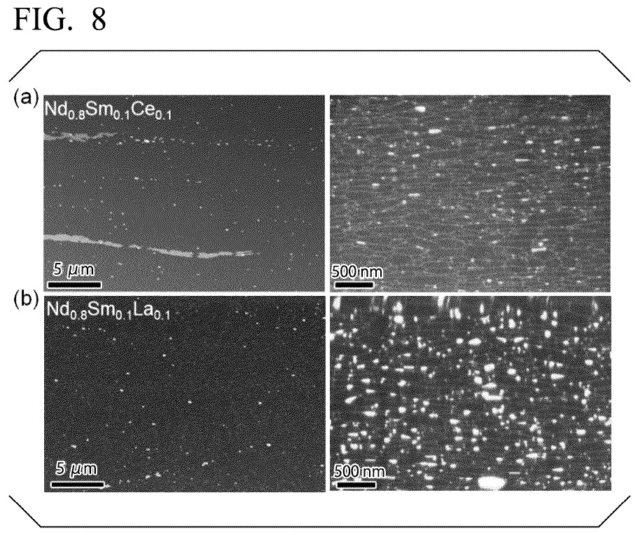

FIGS. 8(a) and 8(b) show BSE-SEM images of the hot-deformed (Nd_{0.8}Sm_{0.1}Ce_{0.1})—Fe—B magnet and BSE-SEM images of the hot-deformed (Nd_{0.8}Sm_{0.1}La_{0.1})—Fe—B magnet. Each left side is a low-magnification image (with a scale bar of 5 μm), and each right side is a high-magnification image (with a scale bar of 500 nm).

A gray contrast (Sm,Ce)Fe₂ phase was observed in the interfacial region of the original flakes of the hot-deformed (Nd_{0.8}Sm_{0.1}Ce_{0.1})—Fe—B magnet. This is because, in the hot-deformed (Nd_{0.8}Sm_{0.1}La_{0.1})—Fe—B magnet, when Ce was replaced with La, the generation of the (Sm,Ce)Fe₂ phase was inhibited. As a result, the area fraction of the RE-rich triple junction inside the ribbon of the hot-deformed (Nd_{0.8}Sm_{0.1}La_{0.1})—Fe—B magnet increased. Accordingly, it is possible to explain a high coercive force and flatness of the first-order reversal curve (FORC) achieved with the hot-deformed (Nd_{0.8}Sm_{0.1}La_{0.1})—Fe—B magnet.

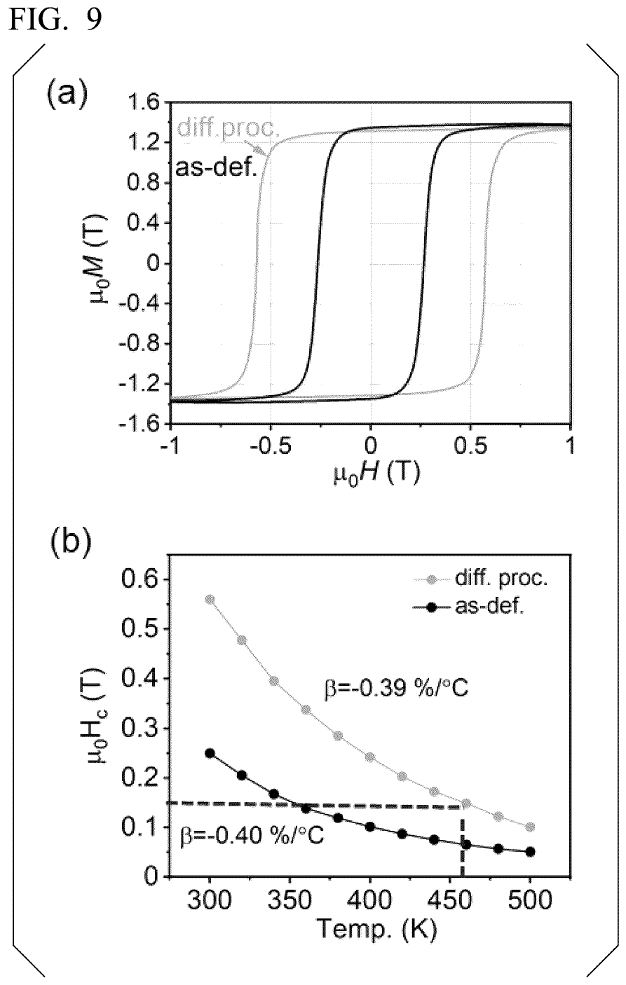

In order to improve the flatness of the FORC, the hot-deformed (Nd_{0.8}Sm_{0.1}La_{0.1})—Fe—B magnet was subjected to a grain boundary diffusion treatment. FIG. 9(a) shows hysteresis curves, and FIG. 9(b) shows the dependence of the coercive force on the temperature.

FIG. 9(a) shows room temperature characteristics of the hot-deformed (Nd_{0.8}Sm_{0.1}La_{0.1})—Fe—B magnet itself and the hot-deformed (Nd_{0.8}Sm_{0.1}La_{0.1})—Fe—B magnet subjected to a 4 wt % Nd—Cu diffusion process. After the Nd—Cu diffusion process was performed, the coercive force μ₀H_{c} increased to 0.56 T, and the residual magnetic flux density μ₀Mᵣ decreased to 1.29 T.

Thanks to the increased coercive force at room temperature, a coercive force of 0.15 T at the applied temperature (460 K) could be achieved. This coercive force is a desirable value for practical use. In other words, the hot-deformed (Nd_{0.8}Sm_{0.1}La_{0.1})—Fe—B magnet subjected to the Nd—Cu diffusion treatment can have a desirable coercive force for use throughout the usage temperature (300-460 K) range.

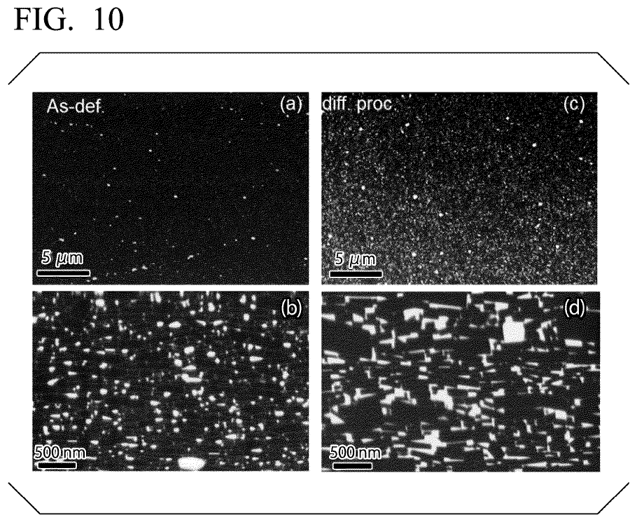

FIGS. 10(a) and 10(b) show BSE-SEM images of the hot-deformed (Nd_{0.8}Sm_{0.1}La_{0.1})—Fe—B magnet itself, and FIGS. 10(c) and 10(d) are BSE-SEM images of the hot-deformed (Nd_{0.8}Sm_{0.1}La_{0.1}—Fe—B magnet subjected to the Nd—Cu diffusion treatment. Each upper side is a low-magnification image (with a scale bar of 5 μm), and each lower side is a high-magnification image (with a scale bar of 500 nm).

As can be seen from FIG. 10, after the grain boundary diffusion process, the area fraction of the RE-rich triple junction region inside the ribbon increases, and the thin grain boundary phase becomes more visible in the hot-deformed magnet.

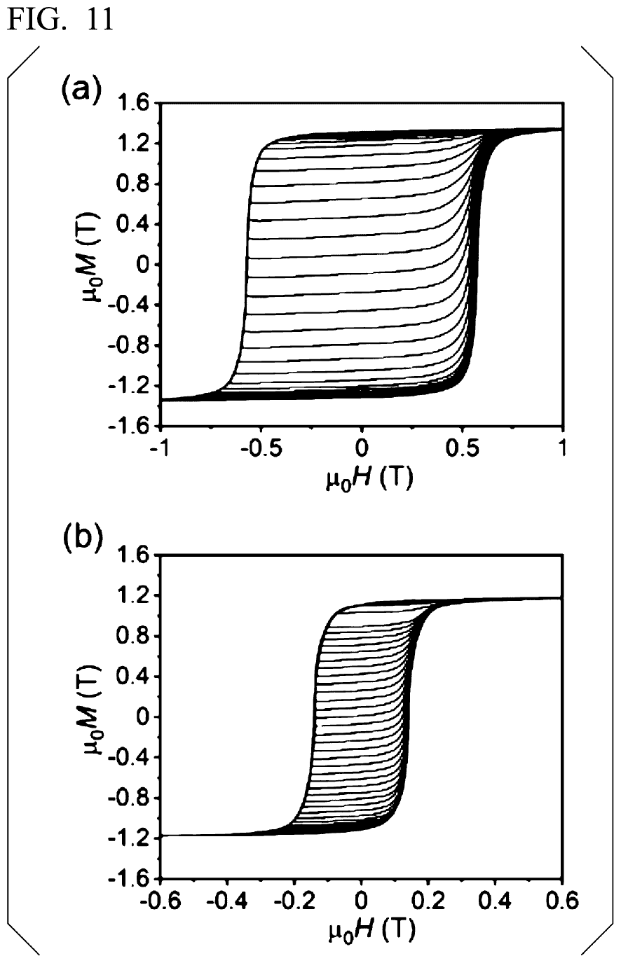

Accordingly, as shown in FIG. 11(a), it is possible to explain a high coercive force and better flatness of the FORC achieved with the hot-deformed (Nd_{0.8}Sm_{0.1}La_{0.1})—Fe—B magnet subjected to the Nd—Cu diffusion treatment.

FIG. 11 shows FORCs of the hot-deformed (Nd_{0.8}Sm_{0.1}La_{0.1})—Fe—B magnet subjected to the Nd—Cu diffusion treatment, FIG. 11(a) shows FORCs at room temperature, and FIG. 11(b) shows FORCs at 460 K.

After the Nd—Cu grain boundary diffusion process, the flatness factor increased from 0.87 to 0.95. This value is the largest value of the flatness factor reported so far for VMF motor applications, and a flatness factor of 0.94 is maintained at high temperatures (460 K).

Table 5 summarizes magnetic characteristics of the hot-deformed Nd_{0.8}Sm_{0.1}LRE_{0.1} magnets (LRE=Ce,La).

TABLE 5

| | | | | μ₀H_{c} | | F_{f} | |
|---|---|---|---|---|---|---|---|
| | | μ₀H_{c} | μ₀Mᵣ | (460 | F_{f} | (460 | |
| | Samples | (RT) | (RT) | K) | (RT) | K) | H_{mag} |
| 11 | Nd_{0.6}La_{0.3}Ce_{0.1} | 0.45 T | 1.26 T | — | 0.75 | — | 1.4 T |
| 18 | Nd_{0.8}S_{m0.1}Ce_{0.1} | 0.16 T | 1.3 T | — | 0.83 | — | 0.45 T |
| 19 | Nd_{0.8}S_{m0.1}L_{a0.1} | 0.25 T | 1.35 T | 0.05 T | 0.87 | — | 0.58 T |
| 20 | Nd_{0.8}S_{m0.1}L_{a0.1} | 0.56 T | 1.29 T | 0.15 T | 0.95 | 0.94 | 0.94 T |
| | Nd—Cu diff. | | | | | | |
| | proc. | | | | | | |

Samples 1 to 18 are classified as having preferable magnetic characteristics as anisotropic hot-deformed R—Fe—B magnets for variable-magnetic-force motors. LaₓCe_{y}Y_{z} in (Nd_{1-x-y-z}LaₓCe_{y}Y_{z})_{12.2-14.5}—Fe_{bal}—Co_{0.0-5.0}—Ga_{0.0-1.0}—B_{5-6.5} (at. %) and SmₛLaₓCe_{y} in (Nd_{1-s-x-y}SmₛLaₓCe_{y})_{12.2-14.5}—Fe_{bal}—Co_{0.0-5.0}—Ga_{0.0-1.0}—B_{5-6.5} (at. %) are used as composition range parameters.

(1) Samples 11, 12, 19, and 20 are listed as those having a residual magnetic flux density μ₀Mr of 1.1 T or more and a coercive force μ₀Hc in a range of 0.2 T or more and 0.65 T or less.

Based on these samples, examples of preferable composition ranges include LaₓCe_{y}Y_{z} (0.2≤x≤0.4, 0.0<y+z≤0.3) and SmₛLaₓCe_{y} (0.0<s≤0.2, 0.0<x+y≤0.2). Examples of more preferable composition ranges include LaₓCe_{y}Y_{z} (0.15≤x≤0.35, 0.05≤y+z≤0.25) and SmₛLaₓCe_{y} (0.05≤s≤0.15, 0.05≤x+y≤0.15).

(2) Samples 6, 10, 11, 12, 19, and 20 are listed as those having a residual magnetic flux density μ₀Mr of 1.1 T or more and a coercive force μ₀Hc in a range of 0.2 T or more and 0.8 T or less.

Based on these samples, examples of preferable composition ranges include LaₓCe_{y}Y_{z} (0.1≤x≤0.4, 0.0≤y+z≤0.3) and SmₛLaₓCe_{y} (0.0<s≤0.2, 0.0≤x+y≤0.2). Examples of more preferable composition ranges include LaₓCe_{y}Y_{z} (0.15≤x≤0.35, 0.0≤y+z≤0.25) and SmₛLaₓCe_{y} (0.05<s≤0.15, 0.05<x+y≤0.15).

(3) Samples 5, 6, 9, 10, 11, 12, 15, 19, and 20 are listed as those having a residual magnetic flux density μ₀Mr of 1.1 T or more and a coercive force μ₀He in a range of 0.2 T or more and 0.9 T or less.

Based on these samples, examples of preferable composition ranges include LaₓCe_{y}Y_{z} (0.0≤x≤0.4, 0.0 y+z≤0.4) and SmₛLaₓCe_{y} (0.0<s≤0.2, 0.0<x+y≤0.2). Examples of more preferable composition ranges include LaₓCe_{y}Y_{z} (0.0≤x≤0.35, 0.15≤y+z≤0.35) and SmₛLaₓCe_{y} (0.05<s≤0.15, 0.05≤x+y≤0.15).

(4) Samples 11, 19, and 20 are listed as those having a residual magnetic flux density μ₀Mr of 1.1 T or more, a coercive force μ₀Hc in a range of 0.2 T or more and 0.65 T or less, and a flatness factor Ff of 0.7 or more.

Based on these samples, examples of preferable composition ranges include LaₓCe_{y}Y_{z}(0.2≤x≤0.4, 0.0<y+z 0.2) and SmₛLaₓCe_{y} (0.0<s≤0.2, 0.0<x+y≤0.2). Examples of more preferable composition ranges include LaₓCe_{y}Y_{z} (0.25≤x≤0.35, 0.05≤y+z≤0.15) and SmₛLaₓCe_{y} (0.05<s≤0.15, 0.05<x+y≤0.15).

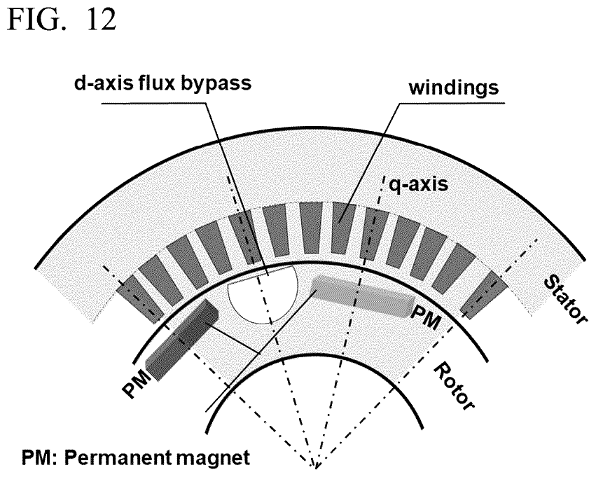

FIG. 12 is a main-part configuration diagram, which shows an example of a variable-magnetic-force motor used in the hot-deformed magnet of the present invention. The variable-magnetic-force motor has a low-magnetic-force mode and a high-magnetic-force mode, and is composed of a wire-wound stator and a permanent magnet rotor. The wire-wound rotor is a rotating part, also called a rotor, and a winding wire is provided therein. The wire-wound rotor is attached to a shaft that serves as an output shaft via a bearing (not shown). The permanent magnet stator is a part that generates a force to rotate the rotor, and a permanent magnet is provided therein. The permanent magnet is a generation source of magnetic fields and is an important material forming the motor. A bracket (not shown) is an integral part that supports the bearing and covers the wire-wound stator.

### INDUSTRIAL APPLICABILITY

According to the hot-deformed R—Fe—B magnet for a variable-magnetic-force motor of the present invention, a hot-deformed R—Fe—B magnet for a variable-magnetic-force motor which has a small coercive force required for VMF motors and in which a magnetic flux of a permanent magnet can be easily controlled is obtained.

1. A hot-deformed R—Fe—B magnet for a variable-magnetic-force motor, which is an R₂—Fe₄—B (R is at least one rare earth element selected from among Nd, La, Ce, and Y)-based hot-deformed magnet, comprising, in atom %,
12.2% or more and 14.5% or less of R₂(Nd_{1-x-y-z}LaₓCe_{y}Y_{z}), where (0.0≤x≤0.2, 0.0≤y+z≤0.3),
5% or more and 6.5% or less of B,
0.0% or more and 5.0% or less of Co, and
0.0% or more and 1.0% or less of Ga,
with the balance being made up of Fe and inevitable impurities.

2. The hot-deformed R—Fe—B magnet for a variable-magnetic-force motor according to claim 1, which also has a residual magnetic flux density μ₀Mr of 1.3 T or more and a coercive force μ₀Hc in a range of 0.1 T or more and 1.6 T or less.

3. A hot-deformed R—Fe—B magnet for a variable-magnetic-force motor, which is an R₂—Fe₁₄—B (R includes Nd and La, and additionally optionally includes at least one rare earth element such as Ce and Y)-based hot-deformed magnet, comprising, in atom %,
12.2% or more and 14.5% or less of R₂(Nd_{1-x-y-z}LaₓCe_{y}Y_{z}), where (0.05≤x≤0.4, 0.0≤y+z≤0.3),
5% or more and 6.5% or less of B,
0.0% or more and 5.0% or less of Co, and
0.0% or more and 1.0% or less of Ga,
with the balance being made up of Fe and inevitable impurities.

4. The hot-deformed R—Fe—B magnet for a variable-magnetic-force motor according to claim 3, which also has a residual magnetic flux density μ₀Mr of 1.0 T or more and 1.30 T or less, and a coercive force μ₀Hc in a range of 0.15 T or more and 1.2 T or less.

5. A hot-deformed R—Fe—B magnet for a variable-magnetic-force motor, which is an R₂—Fe₄—B (R includes Nd and La, and additionally includes at least one rare earth element such as Ce and Y)-based hot-deformed magnet, comprising, in atom %,
12.2% or more and 14.5% or less of R₂(Nd_{1-x-y-z}LaₓCe_{y}Y_{z}), where (0.25≤x≤0.35, 0.1≤y+z≤0.4),
5% or more and 6.5% or less of B,
0.0% or more and 5.0% or less of Co, and
0.0% or more and 1.0% or less of Ga,
with the balance being made up of Fe and inevitable impurities.

6. The hot-deformed R—Fe—B magnet for a variable-magnetic-force motor according to claim 5, which also has a residual magnetic flux density μ₀Mr of 1.0 T or more and 1.25 T or less, and a coercive force μ₀Hc in a range of 0.15 T or more and 1.1 T or less.

7. A hot-deformed R—Fe—B magnet for a variable-magnetic-force motor, which is an R₂—Fe₄—B (R includes Nd and Sm, and additionally includes at least one rare earth element such as La and Ce)-based hot-deformed magnet, comprising, in atom %,
12.2% or more and 14.5% or less of R₂(Nd_{1-s-x-y}SmₛLaₓCe_{y}), where (0.0<s≤0.2, 0.0≤x+y≤0.2),
5% or more and 6.5% or less of B,
0.0% or more and 5.0% or less of Co, and
0.0% or more and 1.0% or less of Ga,
with the balance being made up of Fe and inevitable impurities.

8. The hot-deformed R—Fe—B magnet for a variable-magnetic-force motor according to claim 7, which also has a residual magnetic flux density μ₀Mr of 1.0 T or more and 1.4 T or less, and a coercive force μ₀Hc in a range of 0.1 T or more and 0.7 T or less.

9. A variable-magnetic-force motor using the hot-deformed R—Fe—B magnet for a variable-magnetic-force motor according to claim 1.

10. A vehicle using the variable-magnetic-force motor according to claim 9.

11. A household electronic device using the variable-magnetic-force motor according to claim 9.

12. A variable-magnetic-force motor using the hot-deformed R—Fe—B magnet for a variable-magnetic-force motor according to claim 3.

13. A variable-magnetic-force motor using the hot-deformed R—Fe—B magnet for a variable-magnetic-force motor according to claim 5.

14. A variable-magnetic-force motor using the hot-deformed R—Fe—B magnet for a variable-magnetic-force motor according to claim 7.

15. A vehicle using the variable-magnetic-force motor according to claim 12.

16. A vehicle using the variable-magnetic-force motor according to claim 13.

17. A vehicle using the variable-magnetic-force motor according to claim 14.

18. A household electronic device using the variable-magnetic-force motor according to claim 12.

19. A household electronic device using the variable-magnetic-force motor according to claim 13.

20. A household electronic device using the variable-magnetic-force motor according to claim 14.
